(19) United States
(12) Patent Application Publication
(10) Pub. No.: US 2026/0320833 A1
(43) Pub. Date: Oct. 15, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventors: TOSHIO YAMAZAKI, TOKYO (JP); KEI OISHI, TOKYO (JP); YASUHIRO SUTOU, TOKYO (JP)

(21) Appl. No.: 19/483,666

(22) PCT Filed: May 14, 2024
(86) PCT No.: PCT/JP2024/017784

§ 371 Date: Nov. 12, 2025

(30) Foreign Application Priority Data
May 23, 2023 (JP) 2023-084487

(51) Int. Cl. G06T 7/80; G06T 7/70; G06T 17/05

(52) U.S. Cl. CPC G06T 7/80; G06T 7/70; G06T 17/05

(57) ABSTRACT

Provided is an information processing device including: a deviation determination unit that determines a deviation between a plurality of sensors on the basis of a 3D map and sensing results of the plurality of sensors; and a calibration processing unit that performs calibration of the sensors on the basis of a determination result of the deviation determination unit.

### TECHNICAL FIELD

The present technology relates to an information processing device, an information processing method, and a program.

### BACKGROUND ART

In recent surrounding environment recognition technology for improving the accuracy of automated driving and driving support of a moving body such as an automobile, surrounding environment recognition by a single sensor is rare. In many cases, it is common to combine a plurality of sensors of different types to recognize the surrounding environment.

Then, in order to perform surrounding environment recognition using a plurality of different sensors, it is necessary to integrate imaging results of the respective sensors. For this purpose, a calibration technique for obtaining the relative position and orientation between the sensors is required.

Therefore, a system is disclosed in which calibration of a sensor during traveling is performed by using a map database that stores a calibration point and map information including road information at the calibration point (Patent Document 1).

Furthermore, there is also a method of performing calibration using a measurement result of a 3D measuring instrument. The 3D measuring instrument is a measuring instrument capable of acquiring a 3D structure and reflection intensity around the measuring instrument as a 3D point and reflection intensity at the point, and is also called a 3D laser scanner or the like.

### CITATION LIST

### Patent Document

Patent Document 1: Japanese Patent Application Laid-Open No. 2018-96715

### SUMMARY OF THE INVENTION

### Problems to be Solved by the Invention

However, the technique of Patent Document 1 has problems in that the movement and direction of a vehicle are limited, and the technique is a calibration method of a single sensor and is not calibration between a plurality of sensors, and thus is insufficient for application to a recent surrounding environment recognition technique using a plurality of sensors.

In the technique of Patent Document 1, it is necessary for a vehicle to satisfy a specific condition in order to execute calibration, but the condition is a state in which the vehicle is in a straight posture with respect to a road and the vehicle is accelerating at a constant acceleration, or a state in which the vehicle is traveling along a curve and the vehicle is accelerating at a constant acceleration, and a state in which calibration can be executed is limited.

Furthermore, when calibration is to be performed using a 3D measuring instrument, there are problems in that measurement takes time and calibration can be performed only in a place where the 3D measuring instrument is located.

The present technology has been made in view of such problems, and an object thereof is to provide an information processing device, an information processing method, and a program capable of easily performing calibration of a plurality of sensors.

### Solutions to Problems

In order to solve the above-described problems, a first technology is an information processing device including: a deviation determination unit that determines a deviation between a plurality of sensors on the basis of a 3D map and sensing results of the plurality of sensors; and a calibration processing unit that performs calibration of the plurality of sensors on the basis of a determination result of the deviation determination unit.

Furthermore, a second technology is an information processing method including: determining a deviation between a plurality of sensors on the basis of a 3D map and sensing results of the plurality of sensors; and performing calibration of the sensor on the basis of a determination result of the deviation determination unit.

Moreover, a third technology is a program for causing a computer to execute an information processing method, the method including: determining a deviation between a plurality of sensors on the basis of a 3D map and sensing results of the plurality of sensors; and performing calibration of the sensor on the basis of a determination result of the deviation determination unit.

### BRIEF DESCRIPTION OF DRAWINGS

FIG. 1 is a block diagram illustrating a configuration of an information processing device 100.

FIG. 2 is an explanatory diagram of a camera 200 and a LiDAR 300 provided in an automobile 10.

FIG. 3 is a diagram illustrating a configuration of a 3D map.

FIG. 4 is a flowchart illustrating processing in the information processing device 100.

FIG. 5 is a flowchart illustrating processing in a deviation determination unit 105.

FIG. 6 is an explanatory diagram of processing of detecting a landmark from a camera image.

FIG. 7 is an explanatory diagram of how to obtain the relative position of the camera 200 on the 3D map.

FIG. 8 is an explanatory diagram of how to obtain an error.

FIG. 9 is a flowchart illustrating processing in the deviation determination unit 105.

FIG. 10 is an explanatory diagram of how to obtain the relative position of the LiDAR 300 on the 3D map.

FIG. 11 is an explanatory diagram of a nearest point error.

FIG. 12 is a flowchart illustrating processing in the deviation determination unit 105.

FIG. 13 is an explanatory diagram of coordinate transformation into a LiDAR coordinate system.

FIG. 14 is an explanatory diagram of coordinate transformation into a camera coordinate system.

FIG. 15 is an explanatory diagram of projection onto a camera imaging plane coordinate system.

FIG. 16 is an explanatory diagram of deviation determination between the camera 200 and the LiDAR 300.

FIG. 17 is a block diagram illustrating a configuration of the information processing device 100 according to a first modification.

FIG. 18 is a diagram illustrating a structure of sensing results.

FIG. 19 is a block diagram illustrating a configuration of the information processing device 100 according to a second modification.

FIG. 20 is a block diagram illustrating a configuration of the information processing device 100 according to a third modification.

### MODE FOR CARRYING OUT THE INVENTION

Hereinafter, an embodiment of the present technology will be described with reference to the drawings. Note that the description will be made in the following order.
<Embodiment>
[Configuration of Information Processing Device 100]
[Processing in Information Processing Device 100]
<Modification>
[First Modification]
[Second Modification]
[Third Modification]
[Fourth Modification]
[Other Modifications]

### Embodiment

### [Configuration of Information Processing Device 100]

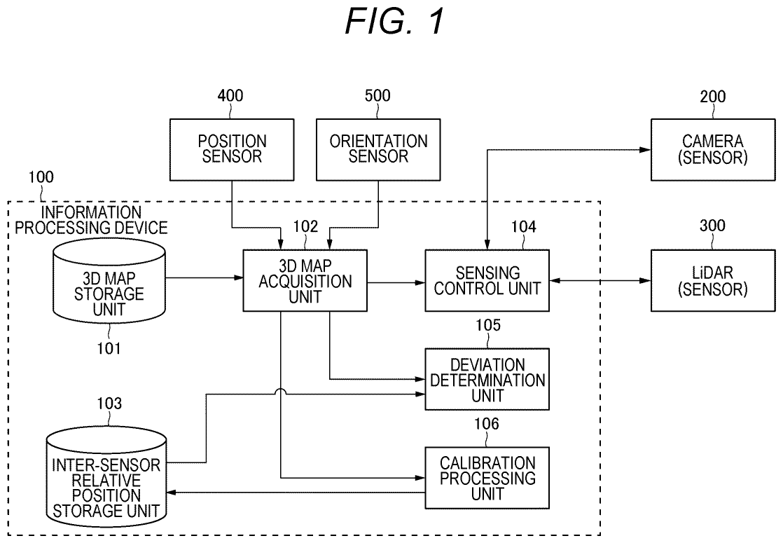

A configuration of an information processing device 100 according to the present embodiment will be described. As illustrated in FIG. 1, the information processing device 100 includes a 3D map storage unit 101, a 3D map acquisition unit 102, an inter-sensor relative position storage unit 103, a sensing control unit 104, a deviation determination unit 105, and a calibration processing unit 106.

A camera 200 and a LiDAR 300 as a plurality of sensors to be calibrated are connected to the information processing device 100. Note that the number of sensors to be calibrated connected to the information processing device 100 is not necessarily two, and may be any number as long as the number is two or more. Furthermore, not all of the plurality of sensors connected to the information processing device 100 are always calibration targets, and any plurality of sensors may be calibration targets. Furthermore, a sensor other than the camera 200 and the LiDAR 300 may be connected to the information processing device.

The camera 200 includes an imaging element, a signal processing circuit, and the like, and is a camera capable of capturing a color image and a video of red, green, blue (RGB) or a single color. An image as a sensing result output from the camera 200 is referred to as a camera image.

The LiDAR 300 is a distance measuring sensor that measures scattered light with respect to irradiation of laser light emitting in a pulse shape, and detects a distance to a target object or substance, a property and a type of the object or the like. The LiDAR 300 outputs sensing results in the form of a 3D point cloud. Note that, although there is a Radar as a distance measuring sensor in the present technology, the Radar can also output a 3D point cloud similarly to the LiDAR 300, and thus calibration can be performed by processing similar to the LiDAR 300. In the present embodiment, the distance measuring sensor is assumed to be the LiDAR 300.

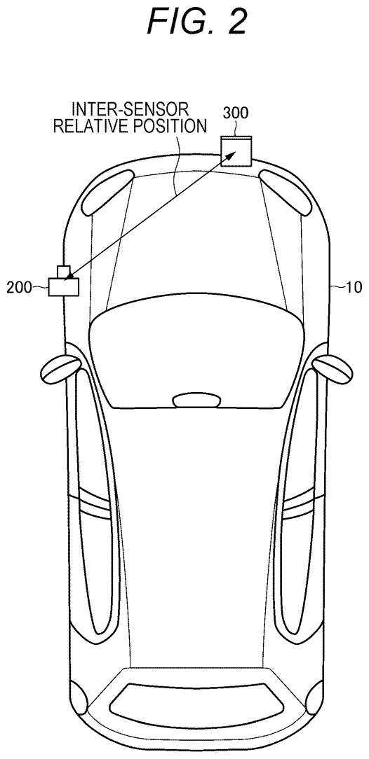

As illustrated in FIG. 2, the camera 200 and the LiDAR 300 are mounted on an automobile 10 as in-vehicle sensors for sensing the surroundings of the automobile 10 as a moving body. As illustrated in FIG. 2, the physical positional relationship between the camera 200 and the LiDAR 300 is referred to as an inter-sensor relative position. It can also be said that the inter-sensor relative position is a parallel movement component and a rotation component. In the example of FIG. 2, one camera 200 and one LiDAR 300 are provided so as to sense the front of the automobile 10, but the numbers and installation positions of the camera 200 and the LiDAR 300 are not limited to this example.

The camera 200 and the LiDAR 300 are connected to the information processing device 100, sense the surroundings of the automobile 10 under the control of the sensing control unit 104, and output the sensing result. The camera 200 and the LiDAR 300 may be connected to the information processing device 100 in a wired manner or in a wireless manner. Examples of the wired connection method include High-Definition Multimedia Interface (HDMI) (registered trademark) and Universal Serial Bus (USB), and examples of the wireless connection method include Wi-Fi, Bluetooth (registered trademark), and Near Field Communication (NFC).

Furthermore, a position sensor 400 and an orientation sensor 500 mounted on the automobile 10 are connected to the information processing device 100.

The position sensor 400 is a sensor such as a global positioning system (GPS) or a global navigation satellite system (GNSS) for acquiring the position of the automobile 10 including the camera 200 and the LiDAR 300.

The orientation sensor 500 is a compass or the like that detects the orientation of the automobile 10 including the camera 200 and the LiDAR 300.

The position sensor 400 and the orientation sensor 500 supply position information and direction information of the automobile 10, which are detection results, to the information processing device 100 at optional timing regardless of a movement state such as traveling or stopping of the automobile 10. The optional timing is, for example, a predetermined time determined in advance once a day, a time point at which the automobile 10 travels continuously for a predetermined time (for example, one hour), or the like.

The position sensor 400 and the orientation sensor 500 may be connected to the information processing device 100 in a wired manner or in a wireless manner. Examples of the wired connection method include HDMI (registered trademark) and USB, and examples of the wireless connection method include Wi-Fi, Bluetooth (registered trademark), and NFC. The position sensor 400 and the orientation sensor 500 may be functions provided in the automobile 10 in advance, or may be configured as a device separate from the automobile 10 and mounted on the automobile 10.

The 3D map storage unit 101 stores a plurality of 3D maps generated in advance. The 3D map storage unit 101 includes, for example, various storage media such as a hard disk and a flash memory. Examples of the 3D map include a map published by the Geospatial Information Authority of Japan or the Ministry of Land, Infrastructure, Transport and Tourism, a map measured and created by a company or the like using a 3D measuring instrument, and the like. However, the 3D map is not limited thereto, and the 3D map includes any 3D map as long as the 3D map is data representing a landscape including the ground surface, terrain, buildings, objects, and the like in three dimensions.

The 3D map acquisition unit 102 confirms whether or not a 3D map close to the position and direction of the automobile 10 exists in the 3D map storage unit 101 on the basis of the position information and the orientation information. The 3D map close to the position and direction of the automobile 10 is a 3D map in which the 3D map is included in a predetermined range based on the position of the automobile 10 and a part or all of the 3D map is included in a direction of a predetermined angle based on the front of the automobile 10.

Then, in a case where a 3D map close to the position and direction of the automobile 10 exists, the 3D map acquisition unit 102 acquires the 3D map and supplies the 3D map to the deviation determination unit 105. Furthermore, the 3D map acquisition unit 102 notifies the sensing control unit 104 that a 3D map close to the position and direction of the automobile 10 exists.

The inter-sensor relative position storage unit 103 stores information on the inter-sensor relative position between the camera 200 and the LiDAR 300 as sensors to be calibrated. The inter-sensor relative position storage unit 103 includes, for example, various storage media such as a hard disk and a flash memory. The inter-sensor relative position stored in the inter-sensor relative position storage unit 103 is updated by the calibration processing unit 106, and the initial value of the inter-sensor relative position is measured, for example, at the time of delivery or factory shipment of the automobile 10 including the camera 200 and the LiDAR 300.

The sensing control unit 104 controls the camera 200 and the LiDAR 300 to sense the surroundings of the automobile 10. The sensing control unit 104 acquires the camera image output from the camera 200 as the sensing result and the 3D point cloud output from the LiDAR 300 as the sensing result, and supplies the acquired camera image and the 3D point cloud to the deviation determination unit 105.

The deviation determination unit 105 determines whether or not the positions of the camera 200 and the LiDAR 300 have deviated on the basis of the sensing result and the 3D map. The deviation determination unit 105 supplies the current inter-sensor relative position obtained at the time of deviation determination to the calibration processing unit 106.

The calibration processing unit 106 performs calibration by storing and updating the current inter-sensor relative position supplied from the deviation determination unit 105 in the inter-sensor relative position storage unit 103 as a new inter-sensor relative position.

The information processing device 100 is configured as described above. The automobile 10 may have a function as the information processing device 100 in advance, a processor included in the automobile 10 may execute the function as the information processing device 100, or the information processing device 100 and the information processing method may be implemented by the automobile 10 having a function as a computer executing a program. Furthermore, an electronic device (a personal computer, a tablet terminal, a smartphone, a server, and the like) separate from the automobile 10 may have the function as the information processing device 100, or the information processing device 100 and the information processing method may be implemented by an electronic device having a function as a computer executing a program. The program may be installed in the automobile 10 or the electronic device in advance, or may be distributed by downloading, a storage medium, or the like and installed by a user or the like. Furthermore, the information processing device 100 may be configured as a single device.

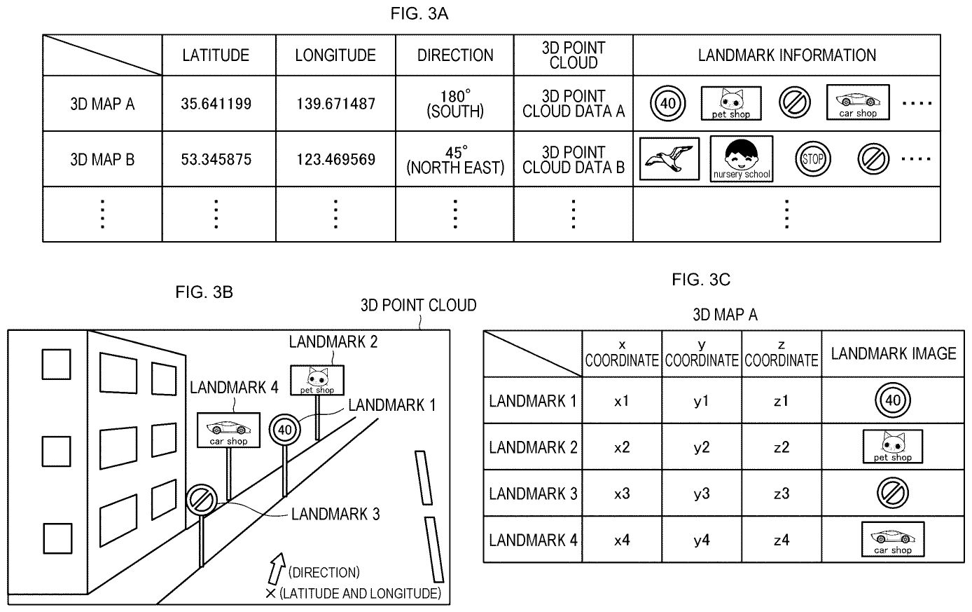

FIG. 3 illustrates the structure of the 3D map stored in the 3D map storage unit 101. The 3D map includes longitude, latitude, direction, 3D point cloud, and landmark information.

The latitude and longitude are information indicating the position of the 3D map. The direction indicates which direction the 3D map is viewed from the position indicated by the latitude and longitude as illustrated in FIG. 3B.

It is desirable to store a large number of 3D maps in different latitudes and longitudes and a large number of 3D maps in different directions in the same latitudes and longitudes in advance in the 3D map storage unit 101. This makes it possible to execute calibration at many positions.

The 3D point cloud is information acquired in advance by a 3D measuring instrument (a 3D laser scanner or the like), a LiDAR, or a Radar, and as illustrated in FIG. 3B, a landscape including the ground surface, terrain, buildings, objects, and the like existing in the compass direction of the direction from a point specified by latitude and longitude is represented by a three-dimensional point cloud. Since the position in the 3D point cloud is a three-dimensional position, the position can be expressed by (x, y, z) coordinates. In the embodiment, a point specified by latitude and longitude is described as an origin.

The 3D structure indicated by the 3D point cloud needs to include three or more planes having one common point in a case where the 3D structure is constituted by planes. The three or more planes are, for example, two walls and one road. Furthermore, in a case where the 3D structure indicated by the 3D point cloud is constituted by a curved surface, it is necessary that the 3D structure be three or more planes having one common point when each curved surface is approximated to a plane.

The landmark information is information indicating a landmark existing in the real world included in the 3D point cloud. The landmark is an object existing in the real world used in the deviation determination. Examples of the landmark include a signboard, a sign, and a building, but the landmark may include any landmark as long as the landmark is an object the position of which does not change.

FIG. 3C illustrates the structure of the landmark information. The landmark information includes an image (hereinafter, referred to as a landmark image) indicating the landmark and position information of the landmark on the 3D point cloud. The landmark image may be an image in the shape of the landmark itself, or may be a rectangular image in which the landmark is shown like a normal image. The landmark image is preferably an image matched with the camera 200 to be calibrated, but is not limited thereto as long as the landmark can be identified.

The position of each landmark on the 3D point cloud is a three-dimensional position and is represented by (xn, yn, zn). In the following description, the existence position (xn, yn, zn) of the landmark on the 3D point cloud of the 3D map may be simply referred to as an existence position (xn, yn, zn). n is a value for identifying each landmark, and takes a value from 1 to n. In the following description, it is assumed that a 3D map A including four landmarks is used, and n is 4. Note that the existence position (xn, yn, zn) of the landmark needs to be a coordinate based on somewhere (for example, the upper left end, the center, or the like of the landmark) of the landmark.

Note that each 3D map needs to include four or more landmark images. As described later, in the present technology, the relative position of each sensor to be calibrated is obtained by a method called perspective-n-point (PnP), but in order to solve the equation in PnP, four or more landmarks are required. Note that the number of landmarks is not limited, and the larger the number, the better.

### [1-2. Processing in Information Processing Device 100]

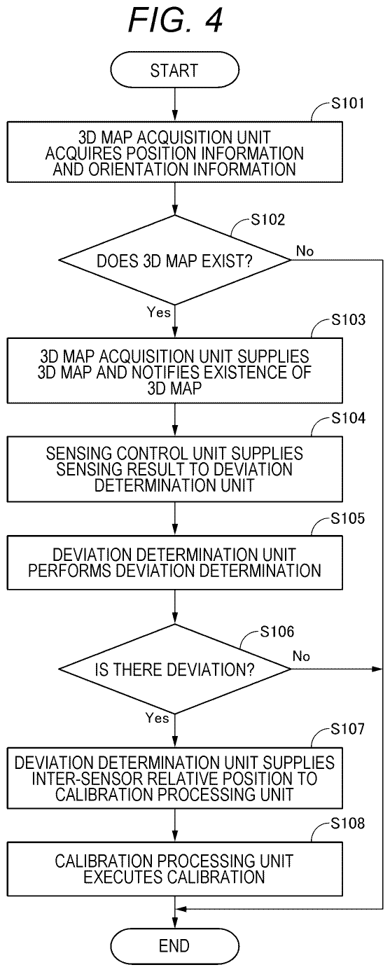

Next, processing in the information processing device 100 will be described with reference to FIG. 4.

First, in step S101, the 3D map acquisition unit 102 acquires current position information of the automobile 10 from the position sensor 400 and acquires current orientation information from the orientation sensor 500.

Next, in step S102, the 3D map acquisition unit 102 confirms whether a 3D map close to the position and direction of the automobile 10 exists in the 3D map storage unit 101 on the basis of the position information and the orientation information. If the 3D map exists, the process proceeds to step S103 (Yes in step S102). Note that, if no 3D map close to the position and direction of the automobile 10 exists, the process ends (No in step S102). In the present embodiment, a description will be given assuming that the 3D map A illustrated in FIG. 3A exists as a 3D map close to the position and direction of the automobile 10.

Next, in step S103, the 3D map acquisition unit 102 acquires the 3D map close to the position and direction of the automobile 10 from the 3D map storage unit 101 and supplies the 3D map to the deviation determination unit 105. Furthermore, the 3D map acquisition unit 102 notifies the sensing control unit 104 that a 3D map close to the position and direction of the automobile 10 exists.

Next, in step S104, the sensing control unit 104 that has received the notification that the 3D map exists controls the camera 200 and the LiDAR 300, which are sensors to be calibrated, to sense the surroundings of the automobile 10. Then, the sensing control unit 104 supplies the camera image, which is the sensing result acquired by the camera 200, and the 3D point cloud, which is the sensing result acquired by the LiDAR 300, to the deviation determination unit 105.

Next, in step S105, the deviation determination unit 105 determines whether the positions of the camera 200 and the LiDAR 300, which are sensors to be calibrated, have deviated. If there is a deviation, the process proceeds from step S106 to step S107 (Yes in step S106). If there is no deviation, the process ends (No in step S106). Details of the processing of the deviation determination unit 105 will be described later.

Next, in step S107, the deviation determination unit 105 supplies information on the current inter-sensor relative position obtained in the deviation determination processing to the calibration processing unit 106.

Then, in step S108, the calibration processing unit 106 executes calibration by updating the inter-sensor relative position storage unit 103 with the current inter-sensor relative position supplied from the deviation determination unit 105 as a new inter-sensor relative position.

Next, processing of the deviation determination unit 105 in step S105 will be described. The deviation determination unit 105 determines a positional deviation of the camera 200, a positional deviation of the LiDAR 300, and a positional deviation between the camera 200 and the LiDAR 300.

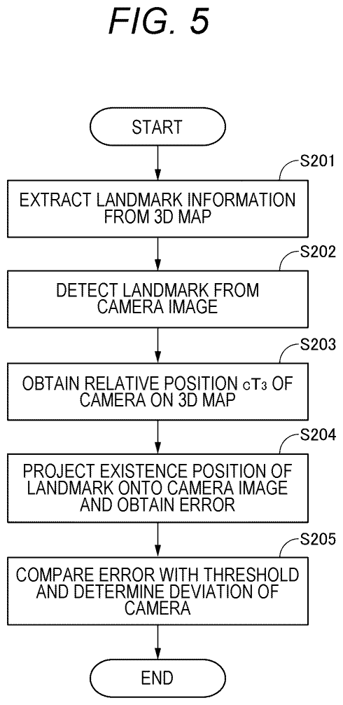

First, processing of determining the deviation of the camera 200 will be described with reference to FIG. 5.

In step S201, the deviation determination unit 105 extracts landmark information from the 3D map supplied from the 3D map acquisition unit 102.

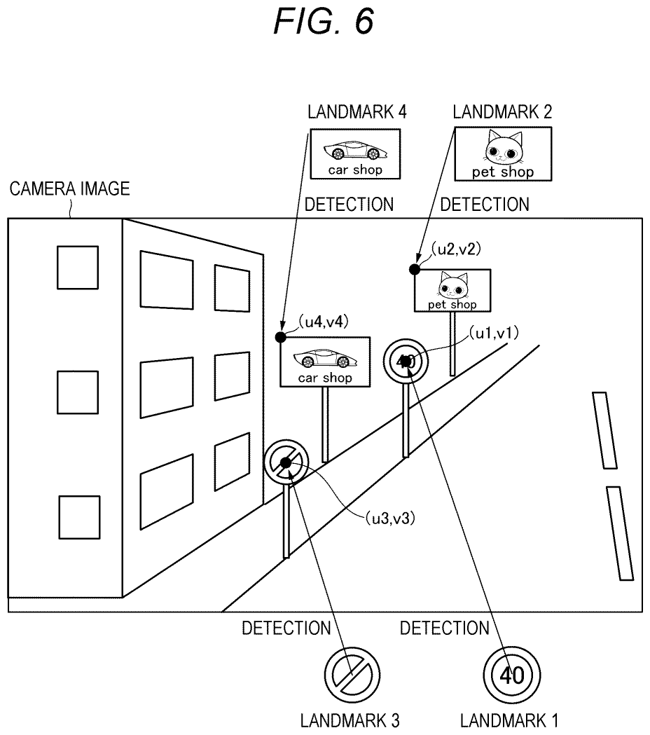

Next, in step S202, each of a plurality of the landmarks is detected from the camera image as illustrated in FIG. 6. The detection position of each landmark is represented by (un, vn) as a two-dimensional position. In the following description, the detection position (un, vn) of the landmark in the camera image may be simply referred to as a detection position (un, vn). n is a value for identifying the plurality of landmarks, and takes a value from 1 to n. In the present embodiment, since there are four landmarks, the landmark 1, the landmark 2, the landmark 3, and the landmark 4 are detected from the camera image.

The detection of the landmarks can be performed by machine learning such as deep neural network (DNN), convolutional neural network (CNN), or random forest (RF), artificial intelligence, or the like. As a learning method of machine learning, for example, a neural network or deep learning is used. Furthermore, the detection processing may be performed using a known object detection technique such as a method using template matching or a matching method based on luminance distribution information of a subject.

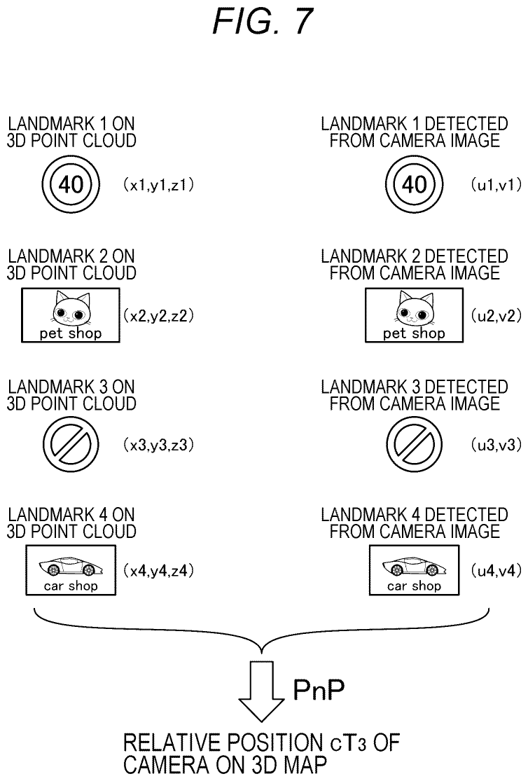

Next, in step S203, as illustrated in FIG. 7, perspective-n-point (PnP) is performed between the existence position (xn, yn, zn) of each landmark on the 3D point cloud of the 3D map and the detection position (un, vn) of each landmark in the camera image, and a relative position _{c}T₃ of the camera 200 on the 3D map is obtained. The relative position of the camera 200 on the 3D map is the relative position of the camera 200 in the 3D point cloud included in the 3D map.

In the present embodiment, since n is 4, PnP is performed on the existence positions (x1, y1, z1), (x2, y2, z2), (x3, y3, z3), and (x4, y4, z4) of the respective landmarks on the 3D point cloud of the 3D map and the detection positions (u1, v1), (u2, v2), (u3, v3), and (u4, v4) of the respective landmarks in the camera image for the landmarks 1 to 4.

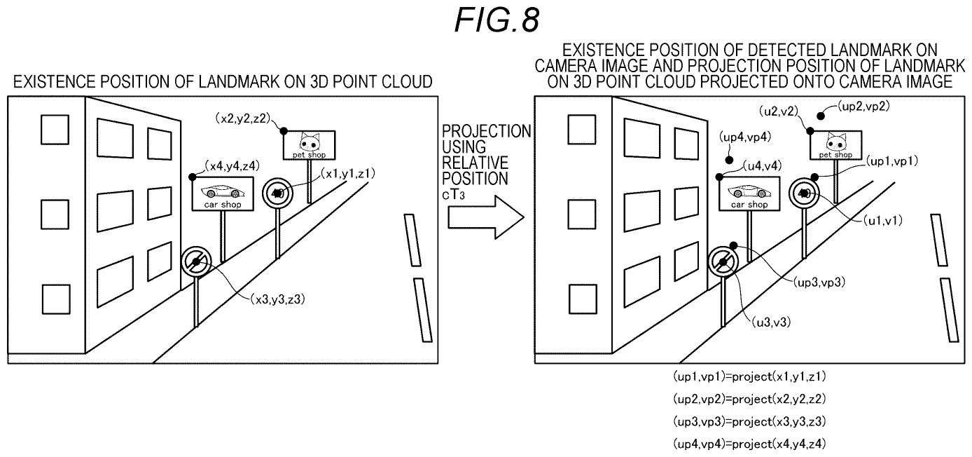

Next, in S204, as illustrated in FIG. 8, the existence position (xn, yn, zn) of the landmark on the 3D point cloud of the 3D map is projected onto the camera image using the relative position _{c}T₃ of the camera 200 on the 3D map.

When the existence position of the landmark on the 3D point cloud of the 3D map is P₃ and the projection position of the landmark on the 3D point cloud of the 3D map onto the camera image is P_{duv}, the projection function (project function) of the landmark onto the camera image is expressed by the following Expression 1 using the relative position _{c}T₃.

P_{duv}=lens_distortion(K·_{c}T₃·P₃) [Expression 1]

In Expression 1, K is a camera matrix of the camera 200 (or an internal parameter matrix of the camera 200). Furthermore, lens_distortion is a function that adds lens distortion of the camera 200.

The projection position P_{duv}, which is the position of each landmark projected onto the camera image, is a two-dimensional position, and is expressed as (upn, vpn). In the following description, the projection position (upn, vpn) of each landmark onto the camera image may be simply referred to as a projection position (upn, vpn). The projection position (upn, vpn) can be expressed by the following Expression 2 using the existence position (xn, yn, zn) of the landmark on the 3D point cloud of the 3D map.

(upn,vpn)=project(xn,yn,zn) [Expression 2]

Then, an error between the projection position (upn, vpn) of each landmark on the 3D point cloud of the 3D map onto the camera image and the detection position (un, vn) of each landmark in the camera image is obtained.

For the landmark 1, the difference between the projection position (up1, vp1) and the detection position (u1, v1) is an error. For the landmark 2, the difference between the projection position (up2, vp2) and the detection position (u2, v2) is an error. For the landmark 3, the difference between the projection position (up3, vp3) and the detection position (u3, v3) is an error. For the landmark 4, the difference between the projection position (up4, vp4) and the detection position (u4, v4) is an error.

Note that, since the number of the projection position (upn, vpn) of the landmark on the 3D point cloud of the 3D map onto the camera image and the number of the detection position (un, vn) of the landmark in the camera image are each the same as the number of the plurality of landmarks, for example, the determination may be made by obtaining one value by simple average, mean square error, or the like, or it may be determined that there is a deviation when the ratio of points exceeding the threshold exceeds a certain threshold.

Then, in step S205, the error is compared with a predetermined threshold, and in a case where the error exceeds the threshold, it is determined that the relative position on the 3D map of the camera 200 that has captured the camera image has deviated. The predetermined threshold is determined by the accuracy required by the application using the output of the sensor. For example, in the case of the camera 200, if the threshold is one pixel or less, it is difficult to observe the deviation, and thus, the threshold is set to one pixel.

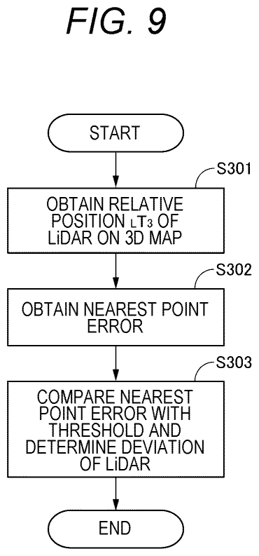

Next, processing of determining the deviation of the LiDAR 300 will be described with reference to FIG. 9.

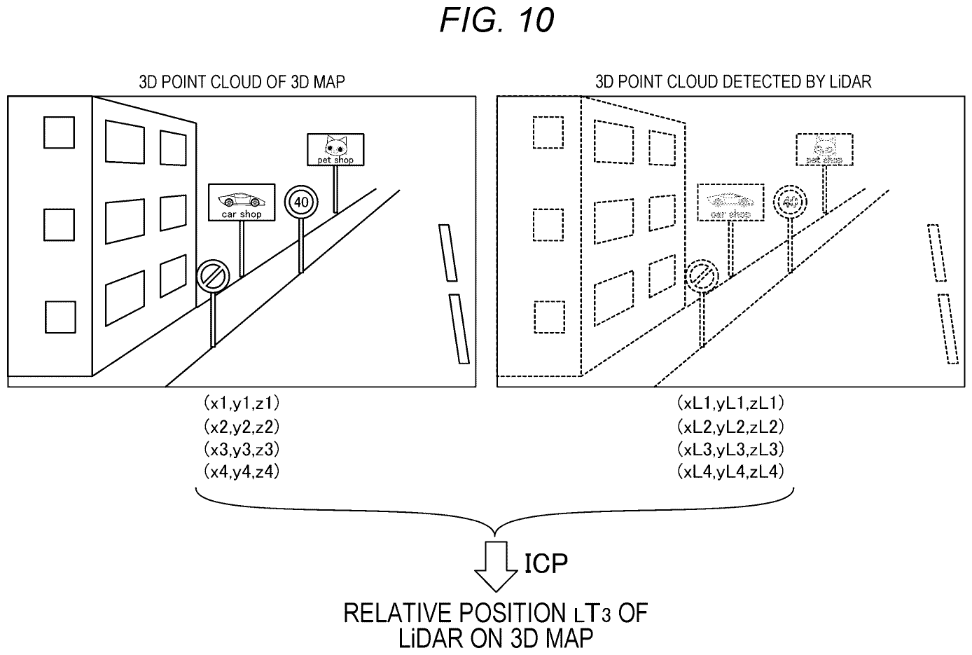

In step S301, as illustrated in FIG. 10, an iterative closest point (ICP) is performed between the 3D point cloud of the 3D map and the 3D point cloud detected by the LiDAR 300, and the relative position _{L}T₃ of the LiDAR 300 on the 3D map is obtained. The relative position _{L}T₃ of the LiDAR 300 on the 3D map is the relative position of the LiDAR 300 in the 3D point cloud included in the 3D map.

The position of the 3D map in the 3D point cloud is expressed as (x, y, z), and the position of the LiDAR 300 in the 3D point cloud is expressed as (xL, yL, zL). Therefore, the position of each landmark in the 3D point cloud of the 3D map can be expressed as (xn, yn, zn), and the position of each landmark in the 3D point cloud of the LiDAR 300 can be expressed as (xLn, yLn, zLn).

Next, in step S302, the 3D point cloud of the 3D map is coordinate-transformed at the relative position _{L}T₃, and a nearest point error is obtained with respect to the 3D point cloud detected by the LiDAR 300.

When the 3D point cloud of the 3D map is coordinate-transformed at the relative position _{L}T₃, the coordinate system of the 3D point cloud of the 3D map becomes the coordinate system of the LiDAR 300. Therefore, if the 3D point cloud of the 3D map and the 3D point cloud of the LiDAR 300 have not deviated, the 3D point cloud of the 3D map after the coordinate transformation and the 3D point cloud of the LiDAR 300 should coincide with each other.

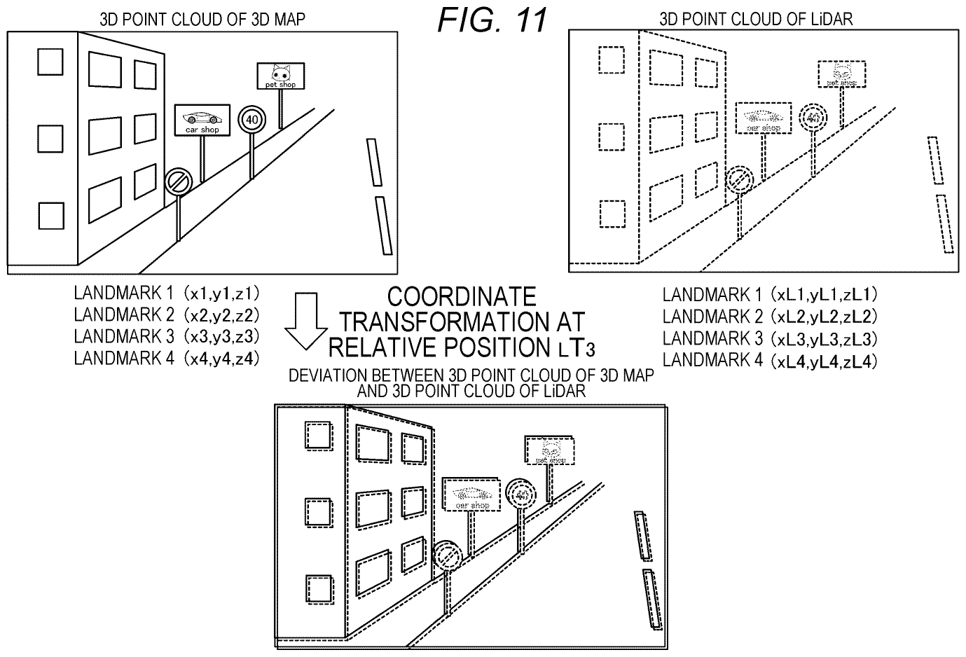

On the other hand, if the 3D point cloud of the 3D map and the 3D point cloud of the LiDAR 300 have deviated, the 3D point cloud of the 3D map after the coordinate transformation and the 3D point cloud of the LiDAR 300 do not coincide with each other and deviates as illustrated in FIG. 11.

Therefore, when the difference between the nearest points of each point between the overlapped 3D point cloud is obtained, the difference becomes the evaluation value of the deviation.

The evaluation value is defined as a nearest point error. The nearest point error may be evaluated individually, but since the number of 3D points is enormous unlike the case of the camera 200, one value is obtained by simple average, mean square error, or the like, and the one value is used as the nearest point error.

Next, in step S303, the deviation determination unit 105 compares the nearest point error with a predetermined threshold, and in a case where the nearest point error exceeds the threshold, it is determined that the relative position on the 3D map of the LiDAR 300 that has detected the 3D point cloud has deviated. The predetermined threshold is determined by the accuracy required by the application using the output of the sensor. For example, in the case of the LiDAR 300, if the deviation is the distance measurement accuracy or less, it is difficult to determine whether the deviation is due to a deviation or the distance measurement accuracy, and thus, the threshold is set to the distance measurement accuracy or less of the LiDAR 300.

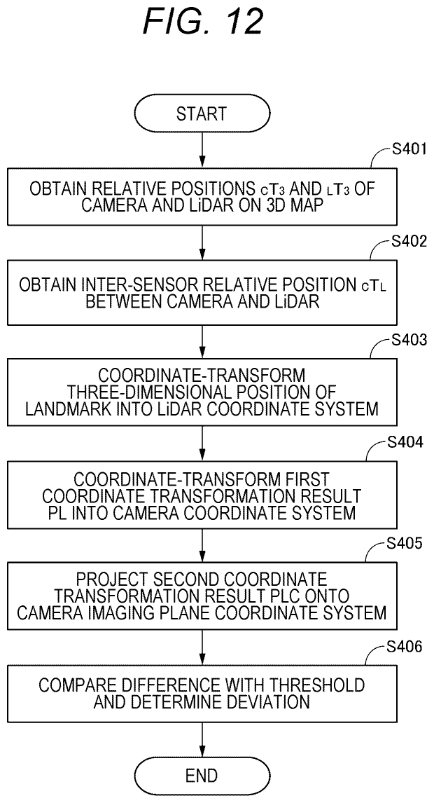

Next, processing of determining the positional deviation between the camera 200 and the LiDAR 300 will be described with reference to FIG. 12.

First, in step S401, the relative position _{c}T₃ of the camera 200 on the 3D map is obtained in a similar manner to the case of the deviation determination of the camera 200 described above. Furthermore, the relative position _{L}T₃ of the LiDAR 300 on the 3D map is obtained in a similar manner to the case of the deviation determination of the LiDAR 300 described above.

Next, in step S402, the relative position _{c}T₃ and the relative position _{L}T₃ are combined to obtain the current relative position between the camera 200 and the LiDAR 300, that is, the current inter-sensor relative position _{c}T_{L}.

Here, how to obtain the inter-sensor relative position _{c}T_{L} will be described. When the rotation from an A coordinate system to a B coordinate system is represented by a 3×3 matrix, and the translation is represented by a 3×1 matrix,
_{B}R_{A}: 3×3 matrix representing rotation from the A coordinate system to the B coordinate system
_{B}P_{A}: 3×1 matrix representing translation from the A coordinate system to the B coordinate system.

At this time, the transformation from the A coordinate system to the B coordinate system is expressed by the following Expression 3.

$${}_{B} {T}_{A} = ( \begin{matrix}{}_{B} {R}_{A} & {}_{B} {P}_{A} \\ 0 & 1\end{matrix} ) : {}_{B} {R}_{A} ∈ SO 3 , {}_{B} {P}_{A} ∈ {R}^{3} \qquad [ Expression 3 ]$$

The relative position obtained by PnP and ICP is _{B}T_{A} in Expression 3.

Since the coordinate transformation is expressed by the rotation matrix and the translation vector between the coordinate systems, the inter-sensor relative position _{c}T_{L} between the camera 200 and the LiDAR 300 can be calculated by the following Expression 4 using the relative position _{c}T₃ and the relative position _{L}T₃.

_{c}T_{L}=_{c}T₃×₃T_{L}=_{c}T₃×(_{L}T₃)⁻¹ [Expression 4]

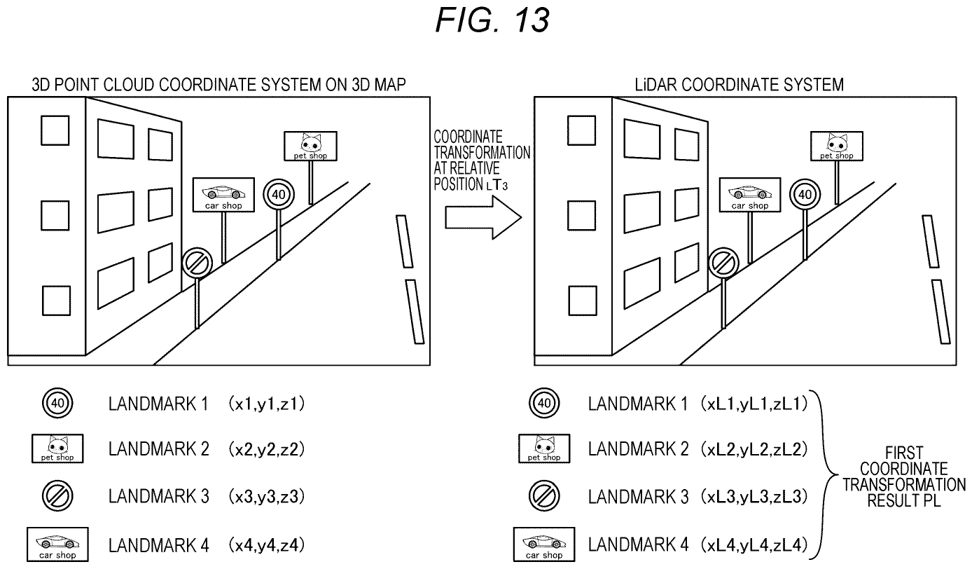

Next, in step S403, the existence position (xn, yn, zn) of the landmark on the 3D point cloud of the 3D map is coordinate-transformed into the LiDAR coordinate system at the relative position _{L}T₃. This processing means that, as illustrated in FIG. 13, the existence position (xn, yn, zn) of each landmark in the 3D point cloud coordinate system on the 3D map is coordinate-transformed into the LiDAR coordinate system at the relative position _{L}T₃. The existence position of each landmark after the coordinate transformation into the LiDAR coordinate system is set as (xLn, yLn, zLn), and the result of the coordinate transformation of the existence positions of all the landmarks is set as a first coordinate transformation result PL.

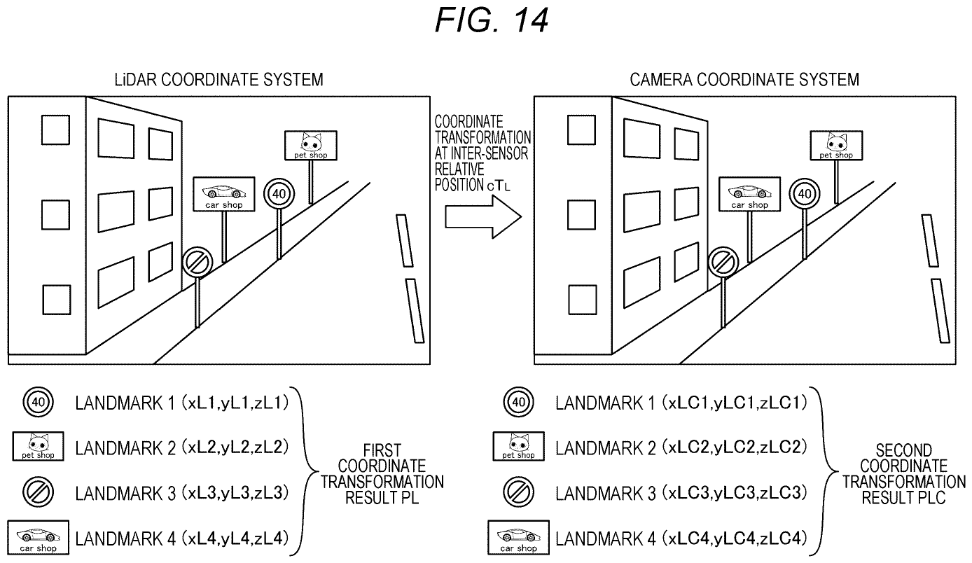

Next, in step S404, the first coordinate transformation result PL is coordinate-transformed into the camera coordinate system at the current inter-sensor relative position _{c}T_{L}. As illustrated in FIG. 14, this processing means that the existence position (xLn, yLn, zLn) of each landmark transformed into the LiDAR coordinate system is coordinate-transformed into the camera coordinate system. The existence position of each landmark after the coordinate transformation into the camera coordinate system is set as (xLCn, yLCn, zLCn), and the result of the coordinate transformation of the existence positions of all the landmarks is set as a second coordinate transformation result PLC.

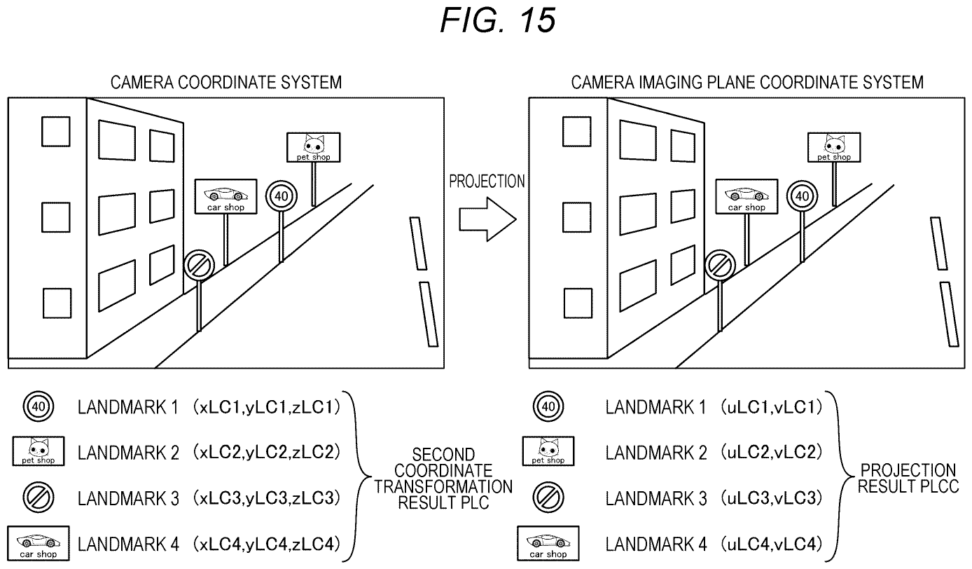

Next, in step S405, the second coordinate transformation result PLC is projected onto the camera imaging plane coordinate system. As illustrated in FIG. 15, this processing means that the existence position (xLCn, yLCn, zLCn) of each landmark coordinate-transformed into the camera coordinate system is projected onto the camera imaging plane coordinate system. Note that Expression 1 described above is used as the projection function. The existence position of each landmark after the coordinate transformation into the camera imaging plane coordinate system is set as (uLCn, vLCn), and the projection result of the existence positions of all the landmarks is set as a projection result PLCC.

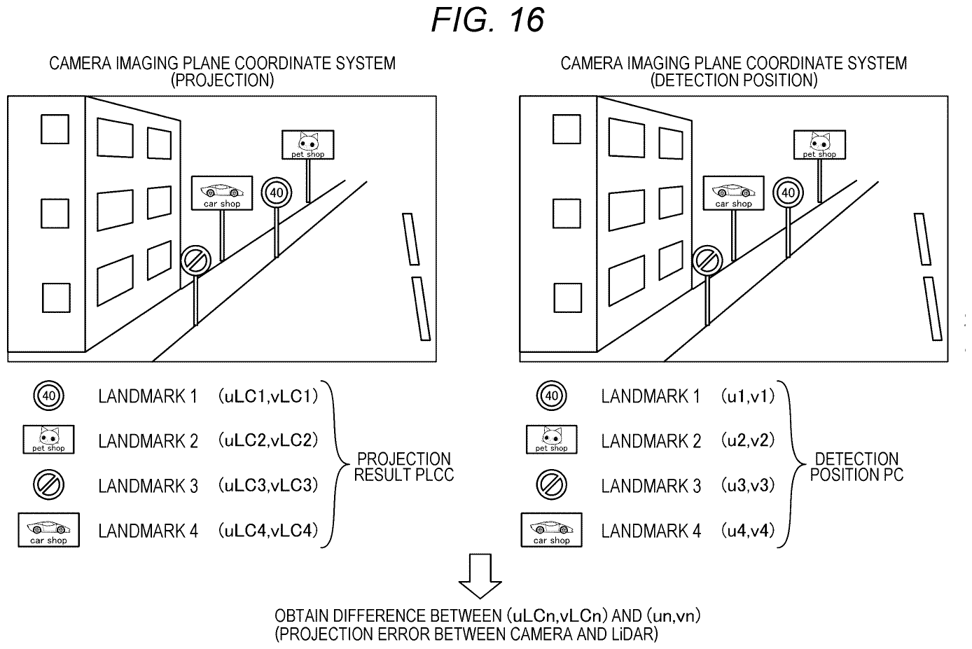

Next, in step S406, as illustrated in FIG. 16, a difference between the projection result PLCC onto the camera imaging plane coordinate system and a detection position PC of the landmark in the camera image detected in the deviation determination of the camera 200 described above is obtained. Then, in a case where the difference exceeds the predetermined threshold, it is determined that the current inter-sensor relative position _{c}T_{L} between the camera 200 and the LiDAR 300 and the inter-sensor relative position acquired from the inter-sensor relative position storage unit 103 have deviated. The predetermined threshold is determined by the accuracy required by the application using the output of this sensor. For example, in the case of the camera 200, if the threshold is one pixel or less, it is difficult to observe the deviation, and thus, the threshold is set to one pixel.

The difference from the case of the deviation determination of the camera 200 described above is that the existence position of the landmark in the 3D point cloud is coordinate-transformed at the relative position _{L}T₃ of the LiDAR 300 on the 3D map and at the current inter-sensor relative position _{c}T_{L} between the camera 200 and the LiDAR 300, and the difference from the detection position PC of the landmark in the camera image is calculated using the projection result PLCC projected onto the camera imaging plane coordinate system. No matter how large the deviation of the inter-sensor relative position _{c}T_{L} is, there is no problem for the user of the automobile 10 as long as the projection result PLCC has not deviated, and even if the deviation of the inter-sensor relative position _{c}T_{L} is small, there is a problem for the user as long as the projection result PLCC has greatly deviated. Therefore, as described above, the deviation between the inter-sensor relative positions _{c}T_{L} between the sensors of the camera 200 and the LiDAR 300 is determined on the basis of the projection result PLCC.

Furthermore, also in this case, similarly to the deviation determination of the camera 200 described above, for example, determination may be made by obtaining one value by simple average, mean square error, or the like, or it may be determined that there is a deviation when the ratio of points exceeding the threshold exceeds a certain threshold.

When determining that the current inter-sensor relative position _{c}T_{L} between the camera 200 and the LiDAR 300 has deviated, the deviation determination unit 105 supplies the current inter-sensor relative position _{c}T_{L} obtained at the time of deviation determination to the calibration processing unit 106. Then, the calibration processing unit 106 performs calibration by updating the inter-sensor relative position storage unit 103 with the current inter-sensor relative position _{c}T_{L} as a new relative position.

Note that evaluation between sensors of the same type such as a camera and a camera, and a LiDAR and a LiDAR can be performed in a similar manner as in the case of the deviation determination between the camera 200 and the 3D map and the deviation determination between the LiDAR 300 and the 3D map described above.

Note that the deviation determination unit 105 can also determine the deviation between the camera 200 and the LiDAR 300 by comparing the current inter-sensor relative position _{c}T_{L} with the inter-sensor relative position acquired from the inter-sensor relative position storage unit 103.

In a case where the inter-sensor relative position between the camera 200 and the LiDAR 300 has deviated, it is possible to confirm whether one or both of the camera 200 and the LiDAR 300 have deviated by referring to the deviation of the position of the camera 200 and the deviation of the position of the LiDAR 300.

The processing of the information processing device 100 is performed as described above. According to the present technology, calibration of the plurality of sensors included in the moving body can be easily performed by using the 3D map and the landmarks around the sensor. Furthermore, calibration of the plurality of sensors can be performed without using a special device such as a 3D measuring instrument.

The time required for measurement by the 3D measuring instrument is not required, and the time required for calibration can be reduced. Furthermore, since the 3D measuring instrument is expensive, the cost for executing calibration can be reduced by not using the 3D measuring instrument.

Furthermore, calibration can be performed even in a place where there is no 3D measuring instrument. Moreover, calibration can be performed even when the moving body is moving.

Since the landmark existing in the real world is used in the deviation determination for calibration, a marker or the like that can be imaged by the camera 200 is not necessary, and calibration can be easily performed.

Since calibration of the sensor mounted on the automobile 10 can be easily performed, accuracy of automated driving and driving support of the automobile 10 can be improved. As a result, robust automated driving and driving support can be realized for various environments.

### <Modification>

Although the embodiment of the present technology has been specifically described above, the present technology is not limited to the above-described embodiment, and various modifications based on the technical idea of the present technology are possible.

### [First Modification]

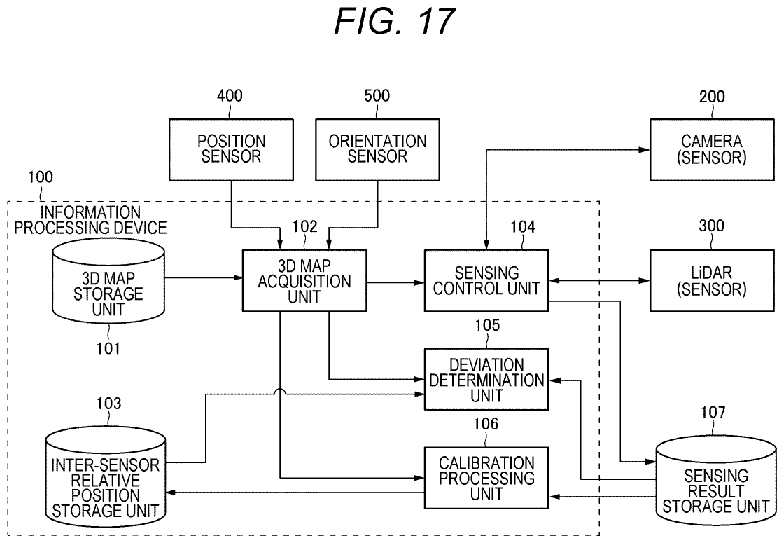

A first modification will be described. As illustrated in FIG. 17, the information processing device 100 according to the first modification is different from the embodiment in including a sensing result storage unit 107. Since the other configurations are similar to those of the embodiment, the description thereof will be omitted.

In the embodiment, it is assumed that one sensing result by a sensor to be calibrated is used. However, accuracy of deviation determination and calibration accuracy can be improved by using a plurality of sensing results. Therefore, in the first modification, deviation determination and calibration are performed using a plurality of sensing results of the sensors to be calibrated.

The sensing result storage unit 107 stores a plurality of sensing results of the sensors to be calibrated. The sensing result storage unit 107 includes various storage media such as a hard disk and a flash memory.

The sensing control unit 104 supplies the sensing results to the sensing result storage unit 107 and accumulates the sensing results in the sensing result storage unit 107. When a predetermined number of sensing results are accumulated in the sensing result storage unit 107, the deviation determination unit 105 performs deviation determination using the plurality of sensing results.

First, similarly to the embodiment, the deviation determination unit 105 determines whether the inter-sensor relative position has deviated using one sensing result. When it is determined that the inter-sensor relative position has deviated, the deviation determination unit 105 supplies the sensing result to the sensing result storage unit 107 and accumulates the sensing results in the sensing result storage unit 107.

When a predetermined number of sensing results are accumulated in the sensing result storage unit 107, the deviation determination unit 105 performs deviation determination using the plurality of sensing results. Then, when determining that the inter-sensor relative position has deviated, the deviation determination unit 105 supplies the inter-sensor relative position _{c}T_{L} to the calibration processing unit 106, and the calibration processing unit 106 executes calibration.

The deviation determination processing in the deviation determination unit 105 is similar to that in the embodiment, but in a case where deviation determination is performed using the plurality of sensing results, a plurality of camera images as sensing results may be combined and processed as one camera image, or deviation determination may be performed individually using each of the plurality of camera images, and calibration may be executed using the median of a plurality of relative positions calculated as a result of deviation determination. Similarly, this applies to the 3D point cloud as the sensing result acquired by the LiDAR 300.

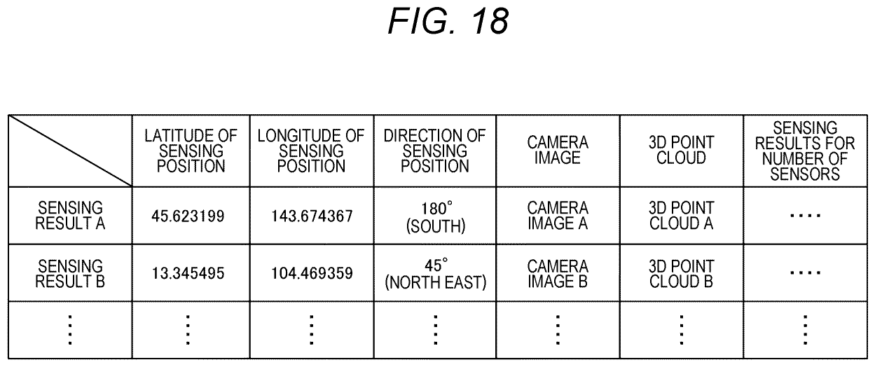

FIG. 18 illustrates an example of the data structure of the sensing result stored in the sensing result storage unit 107. The sensing result is a configuration in which the latitude of the sensing position, the longitude of the sensing position, and the direction of the sensing position are followed by the camera image or the 3D point cloud for the number of sensors to be calibrated.

### [Second Modification]

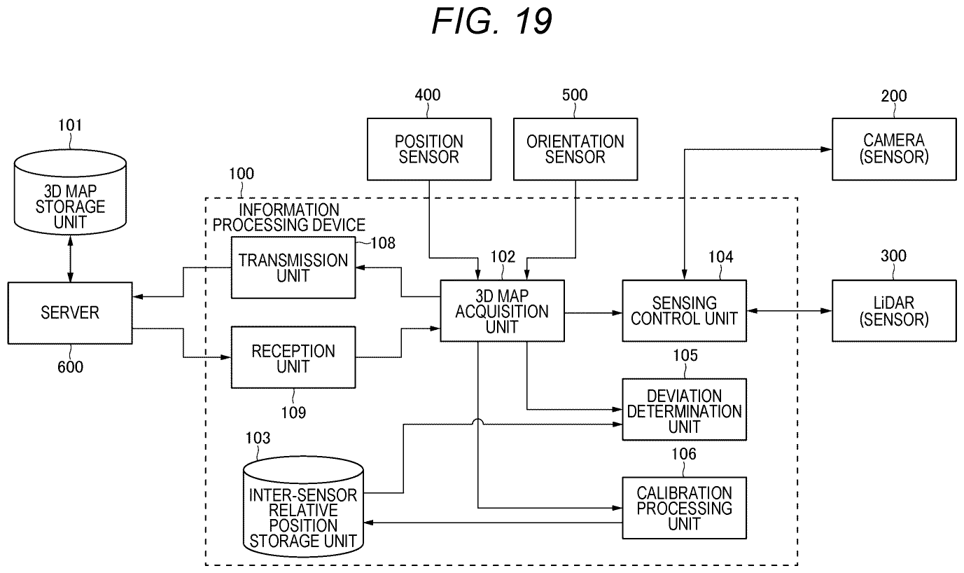

Next, a second modification will be described. As illustrated in FIG. 19, in the second modification, the 3D map storage unit 101 is configured outside the information processing device 100, for example, on a cloud. Furthermore, a server 600 performing processing on the 3D map storage unit 101 is provided. The server 600 performs processing of updating the 3D map in the 3D map storage unit 101, confirming the presence or absence of the 3D map according to the request from the information processing device 100, transmitting the 3D map to the information processing device 100, and the like.

The information processing device 100 includes a transmission unit 108 and a reception unit 109 for communicating with the server 600. The other configurations of the information processing device 100 are similar to those of the embodiment.

On the basis of the position information and the direction information, the 3D map acquisition unit 102 inquires of the server 600 whether the 3D map close to the position and the direction of the automobile 10 exists in the 3D map storage unit 101 via the transmission unit 108. The server 600 confirms whether the 3D map close to the position and the direction exists in the 3D map storage unit 101, and transmits the 3D map to the information processing device 100 in a case where the 3D map exists. Furthermore, in a case where the 3D map does not exist, a flag or the like for giving a notification that the 3D map does not exist is transmitted to the information processing device 100. The 3D map acquisition unit 102 acquires the 3D map or the flag via the reception unit 109. The other processes are similar to those in the embodiment.

According to the second modification, it is possible to solve such problems that it is difficult to update the 3D map since the information processing device 100 operating in a moving body such as the automobile 10 includes the 3D map storage unit 101, and that the information processing device 100 needs to include a huge storage.

Furthermore, by providing the 3D map storage unit 101 outside, the 3D map can be updated by accessing the 3D map storage unit 101 via a network, so that the 3D map can be easily updated. Furthermore, the storage for the database included in the automobile 10 in which the information processing device 100 operates can be reduced.

### [Third Modification]

Next, a third modification will be described. If calibration can be performed in a place where the automobile 10 frequently stops, such as a garage of the owner's house of the automobile 10, the convenience of calibration is expected to be improved. Therefore, when the inter-sensor relative position has not deviated, a place where the automobile 10 frequently stops is sensed by each of the plurality of sensors, and the sensing results are accumulated. Then, deviation determination and calibration of the sensor are executed using the sensing results when there is no deviation.

The time when the sensor has not deviated is, for example, within a certain period after manufacture, within a certain period after calibration is executed, or the like. The period can be confirmed by a calendar/clocking function provided in the automobile 10.

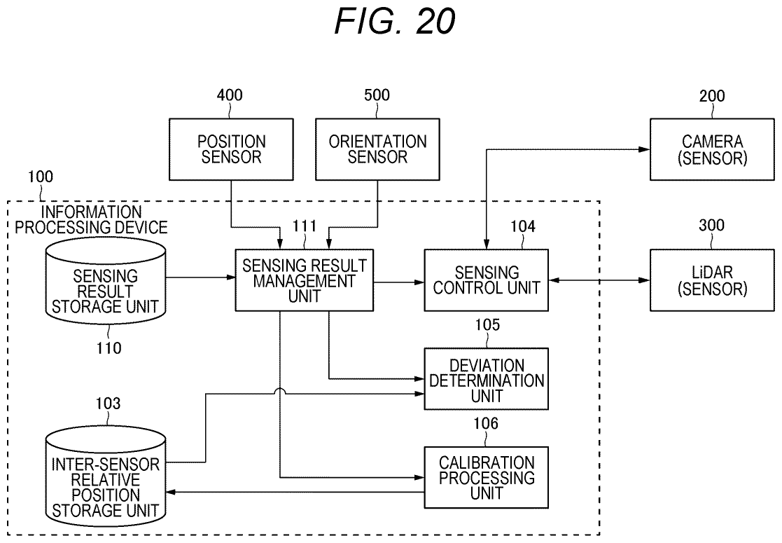

As illustrated in FIG. 20, the information processing device 100 of the third modification includes a sensing result storage unit 110 instead of the 3D map storage unit 101. Furthermore, the information processing device 100 includes a sensing result management unit 111 instead of the 3D map acquisition unit 102. The other configurations of the information processing device 100 are similar to those of the first embodiment.

When the inter-sensor relative position has not deviated, in a case where the sensing result management unit 111 confirms that the automobile 10 including the sensor is present in a place where the automobile 10 frequently stops on the basis of the position information, the position information and the direction information of the automobile 10 and the sensing result of the sensor are output and accumulated in the sensing result storage unit 110 in association with each other.

Then, when the certain period as described above has passed, the sensing result management unit 111 acquires the sensing result from the sensing result storage unit 107 on the basis of the position information and the direction information, and supplies the sensing result to the sensing control unit 104, the deviation determination unit 105, and the calibration processing unit 106. Then, the information processing device 100 performs deviation determination and calibration using a normal sensing result instead of the 3D map in the embodiment.

As described above, by using the sensing result when the inter-sensor relative position has not deviated, the 3D map storage unit 101 becomes unnecessary, and the opportunity to execute calibration can be further increased. Note that the 3D map storage unit 101 may be used in combination with the third modification.

### [Fourth Modification]

Next, a fourth modification will be described. In a case where calibration is not performed for a long time, there is a possibility that the sensor deviates and a malfunction occurs in a function using the sensor. Therefore, it is determined whether the travel distance of the automobile 10 since the time of executing the previous calibration or the elapsed time since the time of executing the previous calibration exceeds a certain threshold. Then, if the travel distance or the elapsed time exceeds the threshold, it is determined that calibration has not been performed for a long time, and a calibration execution recommendation message, guidance information to a nearby calibration-enabling point, and the like are displayed on a display of a navigation system or the like included in the automobile 10. As a result, it is possible to prevent calibration from not being executed for a long period of time.

The calibration-enabling point is a point where the 3D map exists and the landmark exists. Furthermore, as the guidance information, it is conceivable to indicate a route from the current position on the map to the calibration-enabling point. The guidance may be guidance by voice instead of or in combination with the display on the display.

### [Other Modifications]

Although the description has been given assuming that the moving body is the automobile 10 in the embodiment and the modifications, the present technology is not limited to the automobile 10, and can be applied to moving bodies such as hybrid electric vehicles, motorcycles, bicycles, personal mobility, airplanes, drones, ships, robots, construction machines, and agricultural machines (tractors). According to the present technology, it is possible to improve the accuracy of automated driving, automated operation, autonomous movement, and the like of these moving bodies. Moreover, the information processing device 100 may operate in an electronic device such as a personal computer, a smartphone, a tablet terminal, or a wearable device.

The present technology can also have the following configurations.

(1)

An information processing device including:
a deviation determination unit that determines a deviation between a plurality of sensors on the basis of a 3D map and sensing results of the plurality of sensors; and
a calibration processing unit that performs calibration of the plurality of sensors on the basis of a determination result of the deviation determination unit.
   (2)

The information processing device according to (1), in which the deviation determination unit determines a deviation between the plurality of sensors and a deviation of the sensor based on the 3D map.

(3)

The information processing device according to (1) or (2), in which the plurality of sensors includes a camera that outputs a camera image as the sensing result, and a distance measuring sensor that outputs 3D point cloud information as the sensing result.

(4)

The information processing device according to (3), in which
the deviation determination unit obtains an error between a projection result obtained by projecting a position of the landmark in the 3D map onto an imaging plane of the camera and a position of the landmark detected from the camera image, and
determines a deviation between the camera and the distance measuring sensor by comparing the error with a predetermined threshold.
   (5)

The information processing device according to (4), in which
a first coordinate transformation result is obtained by coordinate-transforming the position of the landmark in the 3D map into a coordinate system of the distance measuring sensor,
a second coordinate transformation result is obtained by coordinate-transforming the first coordinate transformation result into a coordinate system of the camera, and
the projection result is obtained by projecting the second coordinate transformation result onto the imaging plane of the camera.
   (6)

The information processing device according to any one of (1) to (5), in which
the deviation determination unit supplies a relative position between the plurality of sensors used in deviation determination to the calibration processing unit, and
the calibration processing unit performs calibration at a relative position between the plurality of sensors.
   (7)

The information processing device according to (6), in which a relative position between the plurality of sensors is obtained by combining the relative positions of the respective plurality of sensors on the 3D map.

(8)

The information processing device according to any one of (1) to (7), in which the sensor is a camera that outputs a camera image as the sensing result.

(9)

The information processing device according to (8), in which
the 3D map includes information of a landmark that is an object existing in the 3D map,
the deviation determination unit obtains an error between a position of the landmark in the 3D map projected onto the camera image and a position of the landmark detected from the camera image, and
determines a deviation of the camera by comparing the error with a predetermined threshold.
   (10)

The information processing device according to (9), in which
the deviation determination unit obtains a relative position of the camera on the 3D map on the basis of a position of the landmark detected from the camera image and a position of the landmark in the 3D map, and
projects the position of the landmark in the 3D map onto the camera image on the basis of the relative position.
   (11)

The information processing device according to any one of (1) to (10), in which the sensor is a distance measuring sensor that outputs a 3D point cloud as the sensing result.

(12)

The information processing device according to (11), in which
the 3D map includes a 3D point cloud,
the deviation determination unit obtains an error between the 3D point cloud of the 3D map and the 3D point cloud output from the distance measuring sensor, and
determines a deviation of the distance measuring sensor by comparing the error with a predetermined threshold.
   (13)

The information processing device according to (12), in which
a relative position of the distance measuring sensor on the 3D map is obtained on the basis of the 3D point cloud of the 3D map and the 3D point cloud output from the distance measuring sensor, and
the 3D point cloud of the 3D map is coordinate-transformed on the basis of the relative position and an error from the 3D point cloud output from the distance measuring sensor is obtained.
   (14)

The information processing device according to any one of (1) to (13), further including a 3D map acquisition unit that acquires the 3D maps corresponding to the plurality of sensors on the basis of positions and directions of the plurality of sensors from a 3D map storage unit that stores a plurality of 3D maps in advance.

(15)

The information processing device according to (14), in which in a case where the 3D map acquisition unit acquires 3D maps corresponding to the positions of the plurality of sensors, outputs of the plurality of sensors are supplied to the deviation determination unit.

(16)

The information processing device according to any one of (1) to (15), in which the plurality of sensors are provided in a moving body.

(17)

An information processing method including:
determining a deviation between a plurality of sensors on the basis of a 3D map and sensing results of the plurality of sensors; and
performing calibration of the sensor on the basis of a determination result of the deviation determination unit.
   (18)

A program for causing a computer to execute an information processing method, the method including:
determining a deviation between a plurality of sensors on the basis of a 3D map and sensing results of the plurality of sensors; and
performing calibration of the sensor on the basis of a determination result of the deviation determination unit.

### REFERENCE SIGNS LIST

10 Automobile
100 Information processing device
101 3D map storage unit
102 3D map acquisition unit
105 Deviation determination unit
106 Calibration processing unit
200 Camera
300 LiDAR

1. An information processing device comprising:
a deviation determination unit that determines a deviation between a plurality of sensors on a basis of a 3D map and sensing results of the plurality of sensors; and
a calibration processing unit that performs calibration of the plurality of sensors on a basis of a determination result of the deviation determination unit.

2. The information processing device according to claim 1, wherein
the deviation determination unit determines a deviation between the plurality of sensors and a deviation of the sensor based on the 3D map.

3. The information processing device according to claim 1, wherein
the plurality of sensors includes a camera that outputs a camera image as the sensing result, and
a distance measuring sensor that outputs 3D point cloud information as the sensing result.

4. The information processing device according to claim 3, wherein
the deviation determination unit obtains an error between a projection result obtained by projecting a position of the landmark in the 3D map onto an imaging plane of the camera and a position of the landmark detected from the camera image, and
determines a deviation between the camera and the distance measuring sensor by comparing the error with a predetermined threshold.

5. The information processing device according to claim 4, wherein
a first coordinate transformation result is obtained by coordinate-transforming the position of the landmark in the 3D map into a coordinate system of the distance measuring sensor,
a second coordinate transformation result is obtained by coordinate-transforming the first coordinate transformation result into a coordinate system of the camera, and
the projection result is obtained by projecting the second coordinate transformation result onto the imaging plane of the camera.

6. The information processing device according to claim 1, wherein
the deviation determination unit supplies a relative position between the plurality of sensors used in deviation determination to the calibration processing unit, and
the calibration processing unit performs calibration at a relative position between the plurality of sensors.

7. The information processing device according to claim 6, wherein
a relative position between the plurality of sensors is obtained by combining the relative positions of the respective plurality of sensors on the 3D map.

8. The information processing device according to claim 1, wherein
the sensor is a camera that outputs a camera image as the sensing result.

9. The information processing device according to claim 8, wherein
the 3D map includes information of a landmark that is an object existing in the 3D map,
the deviation determination unit obtains an error between a position of the landmark in the 3D map projected onto the camera image and a position of the landmark detected from the camera image, and
determines a deviation of the camera by comparing the error with a predetermined threshold.

10. The information processing device according to claim 9, wherein
the deviation determination unit obtains a relative position of the camera on the 3D map on a basis of a position of the landmark detected from the camera image and a position of the landmark in the 3D map, and
projects the position of the landmark in the 3D map onto the camera image on a basis of the relative position.

11. The information processing device according to claim 1, wherein
the sensor is a distance measuring sensor that outputs a 3D point cloud as the sensing result.

12. The information processing device according to claim 11, wherein
the 3D map includes a 3D point cloud,
the deviation determination unit obtains an error between the 3D point cloud of the 3D map and the 3D point cloud output from the distance measuring sensor, and
determines a deviation of the distance measuring sensor by comparing the error with a predetermined threshold.

13. The information processing device according to claim 12, wherein
a relative position of the distance measuring sensor on the 3D map is obtained on a basis of the 3D point cloud of the 3D map and the 3D point cloud output from the distance measuring sensor, and
the 3D point cloud of the 3D map is coordinate-transformed on a basis of the relative position and an error from the 3D point cloud output from the distance measuring sensor is obtained.

14. The information processing device according to claim 1, further comprising:
a 3D map acquisition unit that acquires the 3D maps corresponding to the plurality of sensors on a basis of positions and directions of the plurality of sensors from a 3D map storage unit that stores a plurality of 3D maps in advance.

15. The information processing device according to claim 14, wherein
in a case where the 3D map acquisition unit acquires 3D maps corresponding to the positions of the plurality of sensors, outputs of the plurality of sensors are supplied to the deviation determination unit.

16. The information processing device according to claim 1, wherein
the plurality of sensors are provided in a moving body.

17. An information processing method comprising:
determining a deviation between a plurality of sensors on a basis of a 3D map and sensing results of the plurality of sensors; and
performing calibration of the sensor on a basis of a determination result of the deviation determination unit.

18. A program for causing a computer to execute an information processing method, the method comprising:
determining a deviation between a plurality of sensors on a basis of a 3D map and sensing results of the plurality of sensors; and
performing calibration of the sensor on a basis of a determination result of the deviation determination unit.
